(19) United States
(12) Patent Application Publication
(10) Pub. No.: US 2021/0300060 A1
(43) Pub. Date: Sep. 30, 2021

(54) SIMULTANEOUS COLOR DEVELOPMENT FOR THERMALLY ACTIVATED PRINT MEDIA

(71) Applicant: HEWLETT-PACKARD DEVELOPMENT COMPANY, L.P., Spring, TX (US)

(72) Inventors: Jay S. GONDEK, Vancouver, WA (US); Jason M. QUINTANA, Vancouver, WA (US); Weiyun SUN, Vancouver, WA (US)

(73) Assignee: Hewlett-Packard Development Company, L.P., Spring, TX (US)

(21) Appl. No.: 17/057,765

(22) PCT Filed: Oct. 31, 2018
(86) PCT No.: PCT/US2018/058528

§ 371 Date: Nov. 23, 2020

(51) Int. Cl. B41J 2/32; G06K 15/02

(52) U.S. Cl. CPC B41J 2/32; G06K 15/028; G06K 15/1878; G06K 15/1868

(57) ABSTRACT

In some examples, simultaneous color development for thermally activated print media may include ascertaining an input image that is to be printed using a thermal printhead. Colors that are to be printed may be determined for a plurality of specified pixels of the input image. A plurality of frequencies may be clustered to print each color of the determined colors. Based on the clustered plurality of frequencies, operation of a printhead that is to print the plurality of specified pixels may be controlled.

### BACKGROUND

A variety of techniques may be used for printing on media. One such technique includes the use of thermal printheads. Thermal printheads may utilize a set of resistor elements that are heated to apply heat directly to the media, or to a thermal transfer ribbon. The applied heat may produce a specified print pattern on the media. The specified print pattern may include, for example, text, images, and other such patterns.

### BRIEF DESCRIPTION OF DRAWINGS

Features of the present disclosure are illustrated by way of example and not limited in the following figure(s), in which like numerals indicate like elements, in which:

FIG. 1 illustrates an example layout of an apparatus for simultaneous color development for thermally activated print media;

FIG. 2 illustrates an example cyan activation signal to illustrate operation of the apparatus for simultaneous color development for thermally activated print media of FIG. 1;

FIG. 3 illustrates an example green activation signal to illustrate operation of the apparatus for simultaneous color development for thermally activated print media of FIG. 1;

FIG. 4 illustrates an example intermediate color activation signal to illustrate operation of the apparatus for simultaneous color development for thermally activated print media of FIG. 1;

FIG. 5 illustrates an example yellow activation signal that includes frequency reduction to illustrate operation of the apparatus for simultaneous color development for thermally activated print media of FIG. 1;

FIG. 6 illustrates an example block diagram for performing simultaneous color development for thermally activated print media;

FIG. 7 illustrates an example flowchart of a method for performing simultaneous color development for thermally activated print media; and

FIG. 8 illustrates a further example block diagram for performing simultaneous color development for thermally activated print media.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Apparatuses for simultaneous color development for thermally activated print media, methods for simultaneous color development for thermally activated print media, and non-transitory computer readable media having stored thereon machine readable instructions to provide simultaneous color development for thermally activated print media are disclosed herein. The apparatuses, methods, and non-transitory computer readable media disclosed herein provide for generation of a plurality of colors, such as cyan (C), magenta (M), and yellow (Y), as well as intermediate colors, within and across pixel boundaries. In this regard, the apparatuses, methods, and non-transitory computer readable media disclosed herein provide for generation of a signal that may include dispersed and clustered frequencies to print a plurality of colors in a single pass of a printhead relative to print media.

With respect to technical challenges addressed by the apparatuses, methods, and non-transitory computer readable media disclosed herein, colorant activation processes for thermal print media may activate one line of primary color per pixel. In this regard, it is technically challenging to fill white-spaces between colors, and to minimize or eliminate unintended cross-talk between colorants. These technical challenges may limit the achievable color gamut for one-pass printing on thermal print media. Thermal color activation techniques may separate primary cyan (C), magenta (M), and yellow (Y) signals, and then activate the signals in succession while a pixel passes under the printhead. As the print media passes under the printhead, for each pixel, any yellow in the pixel may be printed first by pulsing the printhead at a single frequency to the yellow activation temperature. Then the signal associated with the magenta temperature may be pulsed at a single frequency to the printhead for any magenta present, followed by cyan. These three activation temperature signals (e.g., yellow, magenta, cyan), may correspond to printhead pulse frequencies, which may be described as inverse frequency, or duty cycle.

In order to address the aforementioned technical challenges, the apparatuses, methods, and non-transitory computer readable media disclosed herein may extend dimensionality of a system with respect to signal space, to thus grow the signal space to include additional colorants, without developing unwanted colors and without leaving white spaces between colors. In this regard, with respect to creation of continuous signals across pixels, there may be frequencies where C, M, and Y may be printed. If the periods associated with these frequencies are tuned, then a specified color (e.g., Y) may be printed over print media at a certain frequency that is not just specific to a pixel, but that is continuous over pixel boundaries. Thus, the apparatuses, methods, and non-transitory computer readable media disclosed herein provide for the generation of continuous pulse patterns to generate a plurality of different colors.

According to examples disclosed herein, the apparatuses, methods, and non-transitory computer readable media disclosed herein may provide for the implementation of a printhead signal control model that provides for the development of multiple color layers within the signal space, and even color layers that are separated.

According to examples disclosed herein, the apparatuses, methods, and non-transitory computer readable media disclosed herein may provide for the generation of a signal space that may include intermediate colors and thermal transitions between colors.

According to examples disclosed herein, the apparatuses, methods, and non-transitory computer readable media disclosed herein may provide for the spanning of the color capability of a print system.

According to examples disclosed herein, the apparatuses, methods, and non-transitory computer readable media disclosed herein may provide for the printing of a continuous color across pixel borders.

For the apparatuses, methods, and non-transitory computer readable media disclosed herein, when a fixed amount of energy is delivered to the printhead over time, the printhead pulses may be uniformly dispersed, or the pulses may be clustered into low-frequency, large clusters, or the signal may be a combination of dispersed and clustered signals. In this regard, the printhead signal may be a combination of a low-frequency, high-energy component with a high frequency low-energy component.

In examples described herein, module(s), as described herein, may be any combination of hardware and programming to implement the functionalities of the respective module(s). In some examples described herein, the combinations of hardware and programming may be implemented in a number of different ways. For example, the programming for the modules may be processor executable instructions stored on a non-transitory machine-readable storage medium and the hardware for the modules may include a processing resource to execute those instructions. In these examples, a computing device implementing such modules may include the machine-readable storage medium storing the instructions and the processing resource to execute the instructions, or the machine-readable storage medium may be separately stored and accessible by the computing device and the processing resource. In some examples, some modules may be implemented in circuitry.

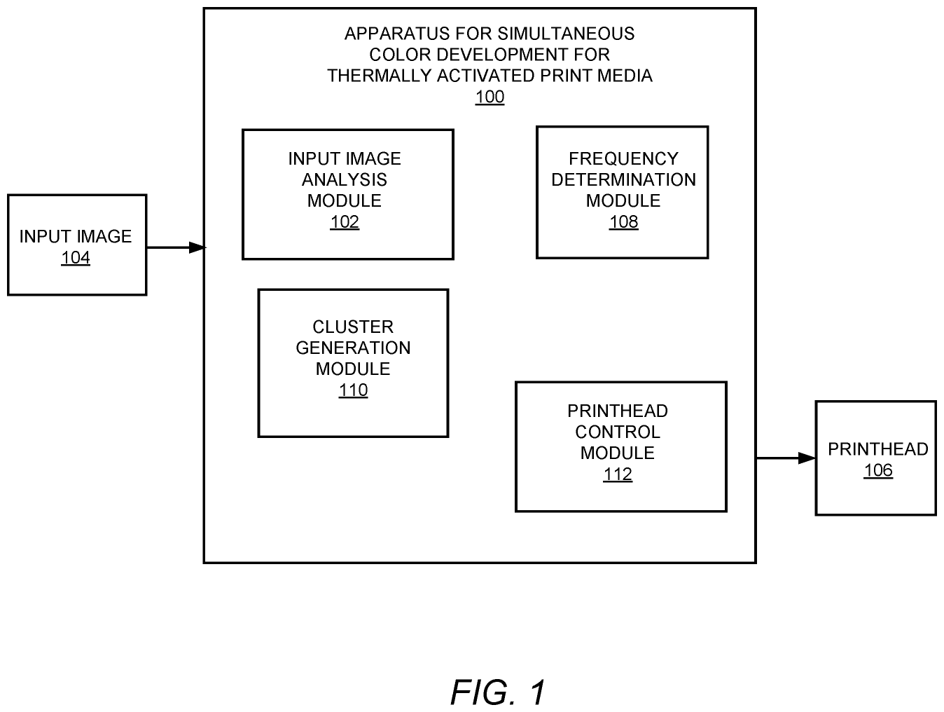

FIG. 1 illustrates an example layout of an apparatus for simultaneous color development for thermally activated print media (hereinafter also referred to as “apparatus 100”).

Referring to FIG. 1, the apparatus 100 may include an input image analysis module 102 to ascertain an input image 104 that is to be printed using a thermal printhead 106.

The input image analysis module 102 may determine, for a plurality of specified pixels of the input image 104, colors that are to be printed. For example, the determined colors may include primary colors such as cyan, magenta, yellow, etc., as well as secondary colors such as green, teal, etc.

A frequency determination module 108 may determine, based on the determined colors that are to be printed, a plurality of frequencies to activate selected colors from the determined colors that are to be printed. In this regard, the selected colors may represent the primary colors.

A cluster generation module 110 may cluster the plurality of frequencies to print each color of the determined colors.

According to examples disclosed herein, the cluster generation module 110 generate a signal that includes the clustered frequencies and dispersed frequencies to print each color of the determined colors.

A printhead control module 112 may control, based on the clustered plurality of frequencies, operation of the printhead 106 that is to print the plurality of specified pixels.

According to examples disclosed herein, a number of the selected colors may be less than a number of the determined colors. For example, the selected colors may include cyan (C), magenta (M), and yellow (Y). In this regard, the determined colors may include colors that are intermediate to C, M, and Y. For example, one of the determined colors may include green (G).

According to examples disclosed herein, the cluster generation module 110 may cluster the plurality of frequencies into a plurality of clusters of equal width. Alternatively or additionally, the cluster generation module 110 may cluster the plurality of frequencies into a plurality of clusters of un-equal width.

According to examples disclosed herein, the printhead control module 112 may control, based on the clustered plurality of frequencies, operation of the printhead 106 that is to print the plurality of specified pixels in a single pass relative to print media.

Operation of the apparatus 100 is described in further detail with reference to FIGS. 1-5.

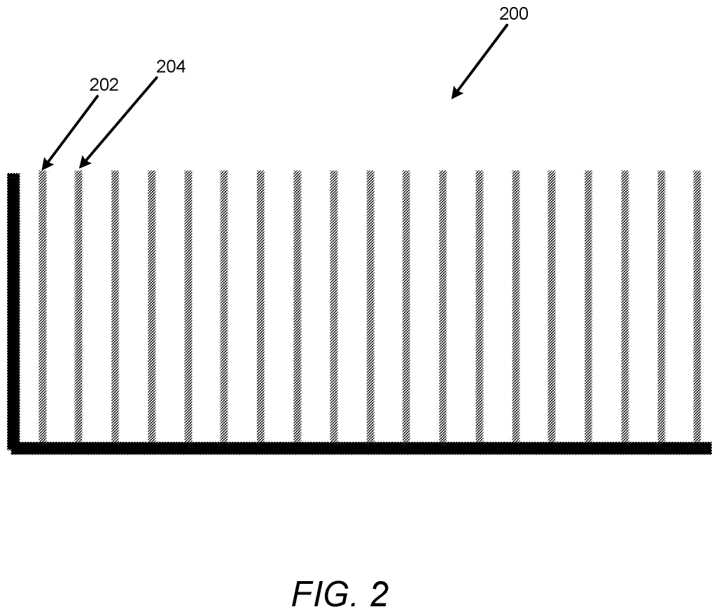

FIG. 2 illustrates an example cyan activation signal to illustrate operation of the apparatus 100.

For an example of print media that may be formed of layers that include yellow as a top layer, magenta as an intermediate layer, and cyan as a bottom layer, with respect to a signal that may activate cyan, cyan may need to be heated to a certain temperature for activation because of its location at the bottom layer. In this regard, heat may need to move through the print media without activating magenta or yellow. In order to accomplish this, a uniform amount of heat per unit time may need to be uniformly spread via the printhead pulses as shown in FIG. 2 at 200. The overall signal shown in FIG. 2 may activate cyan. Further, with the pulses shown at 202, 204, etc., the printhead 106 may not heat the print media to a high enough temperature to active colorants above (e.g., magenta and yellow). For the example of the current stack that includes yellow, magenta, and cyan, the closer the color is to the printhead 106, the more heat it may need to activate, the faster it may respond to heat from the printhead, and the faster it may also cool when the signal is dropped. With respect to cyan which may be located below yellow and magenta, for example, thermals may be slow to build and slow to drop, and thus the thermal effect for deeper colors may be blurred or averaged over a longer time and/or pixel distance. In this regard, cyan may respond to a blurred or lower frequency signal than magenta (in the middle) or yellow (on top).

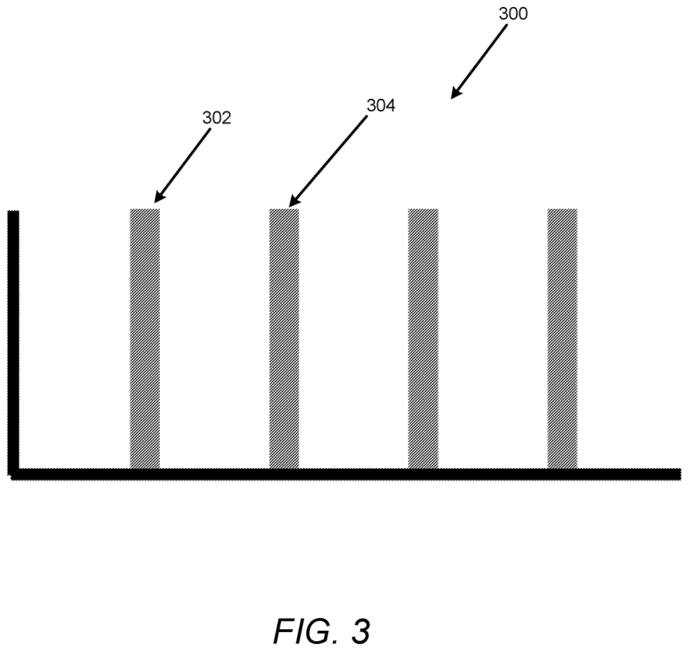

FIG. 3 illustrates an example green activation signal to illustrate operation of the apparatus 100.

Referring to FIG. 3, the cluster generation module 110 may cluster the discrete frequencies of FIG. 2 to simultaneously develop a colorant layer above cyan. For example, the cluster generation module 110 may generate a signal that delivers the energy per time to activate cyan, but does so in low-frequency bursts of high-frequency pulses. For example, if the color green is to be printed, at a certain frequency and pulse duration, heat may be pulsed such that heat into print media may expose yellow with each pulse, but cooling and heating time may be specified such that as the heat penetrates through the print media, the heat may bring up the temperature of bottom layer to develop cyan, and an amount of heat that penetrates through magenta may be low enough to not activate magenta.

Compared to FIG. 2, for FIG. 3, the wide pulses may represent many small pulses (e.g., 12). In this regard, if the pulses uniformly spread out, the resulting color may be cyan. If the pulses are clustered together, and the clusters are spaced far enough apart, the resulting color may be yellow. However, if the pulses are clustered together and the clusters are spaced somewhere in between the pulses for cyan and the clusters yellow, the resulting continuous signal may include a heat signature that pushes the heat into the print media to obtain yellow, but then warm sufficiently to obtain cyan without magenta.

Thus, as shown in FIG. 3, the signal at 300 including the clusters at 302, 304, etc., may be applied across several pixels to obtain a relatively large area of solid green. Thus, in order to generate a specific color, the cluster generation module 110 may determine, for each color, a duration of time that a signal is applied (e.g., a cluster) and a duration of time that if signal is not applied (e.g., the gaps between the clusters) to obtain a desired color. The features such as cluster width, and gaps between clusters, may be determined empirically based on printing color patches that represent a range of possible signals. Thus, for the example of FIG. 3, the high-energy, low-frequency bursts may activate yellow, and may include the energy that is simultaneously injected into the print media to activate cyan.

With respect to pulse-width, in order to generate wider pulses, the cluster generation module 110 may combine the smallest discrete pulses. Intermediate pulse widths may be generated by dithering between integer pulse widths during signal generation. For example, for a signal with a frequency of 1/10 with a pulse width of 2.5, for every 10 pulses, a cluster of either 2 or 3 adjacent pulses (1's) may be generated, followed by a sequence of 8 or 7 0's. A wide pulse may be described as a pulse with a duty cycle of 1 (or a frequency of 1 since they are inversely related). These pulses may provide for the generation of several additional colors and continuous color definitions. In this regard, the colors may be defined continuously and may print continuously across pixel boundaries with a continuous signal.

With respect to the clusters as disclosed herein, a “high” signal cluster and a “low” signal baseline may be defined independently with different high-resolution pulse frequencies. For example, a signal may be generated to include a frequency of 1/100, a cluster-width of 14.3, and cluster magnitude of 0.26. In this regard, for every 100 pulse clocks, a cluster may be printed, where the cluster is on average 14.3 wide, and within that cluster, a pulse frequency may be 0.26.

The cluster generation module 110 may thus generate clusters based on signal parameters that include cluster frequency, cluster magnitude, pulse density, and average energy.

The average energy may be divided between high-energy clusters and low-energy baseline, and regulated by pulse density, which may control the ratio of energy that is printed in a cluster versus outside a cluster.

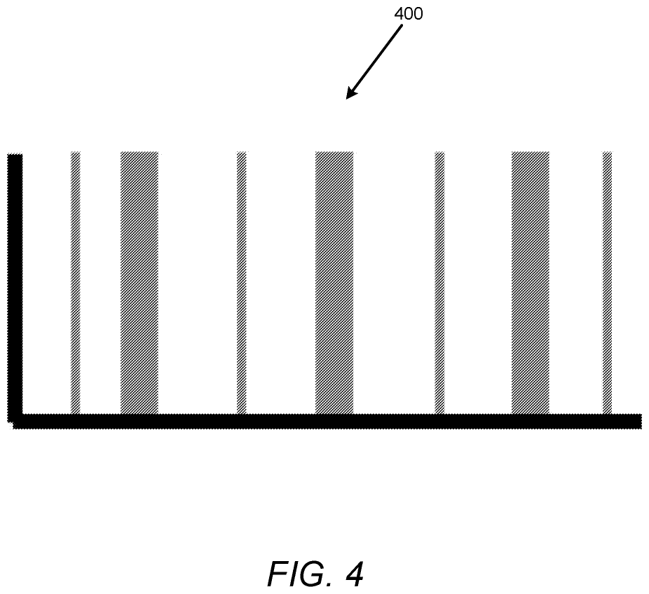

FIG. 4 illustrates an example intermediate color activation signal to illustrate operation of the apparatus 100.

Referring to FIG. 4, the cluster generation module 110 may provide for the generation of intermediate colors, such as teal between green and cyan, either by changing the pulse density, cluster frequency, or both. For example, FIG. 4 illustrates change of cluster frequency, where the clusters may include mixed signals at 400 to activate intermediate colors. With respect to generation of the color teal, areas of the signal space may be printed to determine which signals correspond to which printed colors. Thus, the sequences of applying and removing heat may be used to create intermediate colors.

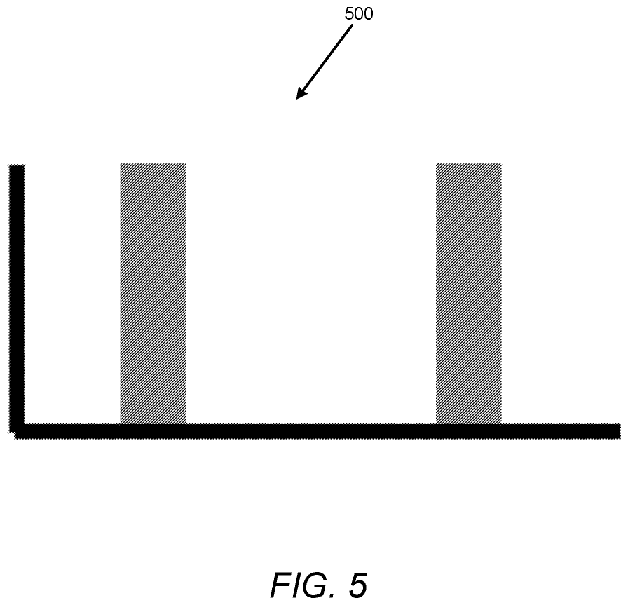

FIG. 5 illustrates an example yellow activation signal that includes frequency reduction to illustrate operation of the apparatus 100.

With respect to an example of a yellow activation signal 500 as shown in FIG. 5, the cluster generation module 110 may provide for transitioning from one color to another (e.g., from green to yellow) by reducing the yellow frequency to the point where it is no longer injecting enough energy over time to active other colorants. For example, with respect to the yellow activation signal 500, if a certain amount of energy is applied over a certain time, how the pulses are clustered together may change the color that is produced. If energy is spread, the resulting color may include cyan. However, if clusters are printed, the resulting color may include magenta. Yet further, if the cluster width is increased, the color yellow may be exposed as the cooling period is not short enough to start cyan exposure. Thus, the patterns may be encoded per pixel color as high-density cluster frequency, high-density cluster pulses, low-density gap frequency, low-density gap pulses, and repeats (which provide for a shorter signal than pixel height). The high energy cluster frequency may determine the clock (or pulse) at which the cluster starts. The cluster pulses may be at a specified frequency until all of the “cluster pulses” have fired, and then the same may occur for the low-density gap, and the signal may repeat.

If a pattern runs into a next pixel, the pattern clock may not be reset at the boundary, and thus continuous pulse stream patterns may continue across pixel boundaries. In this regard, according to examples disclosed herein, more than two signal types may be mixed in the signal definition, and a pattern including several frequency/pulse segments may be defined in the signal, compared to a high-density and low-density segment.

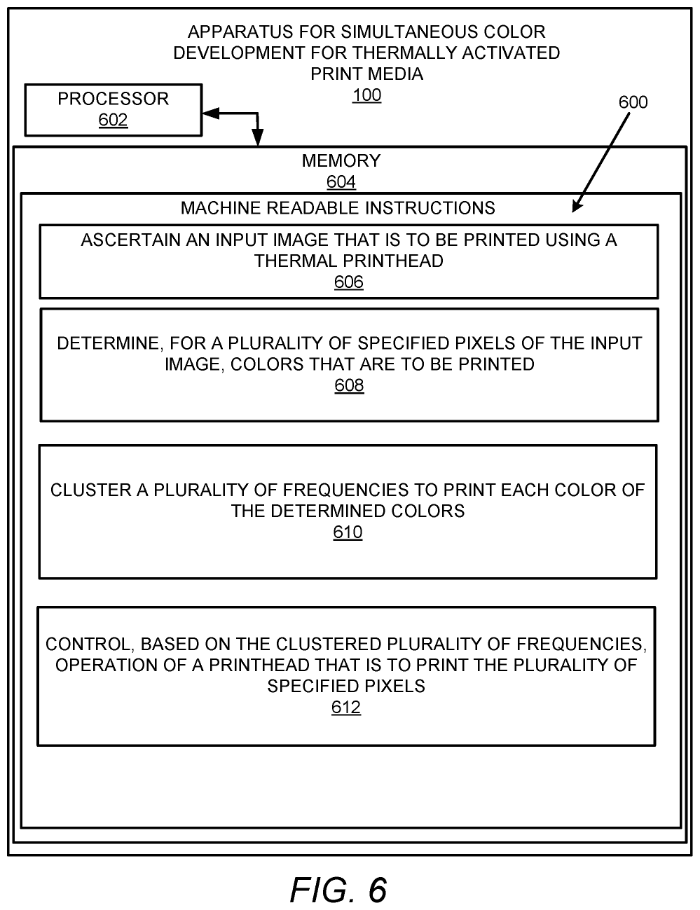

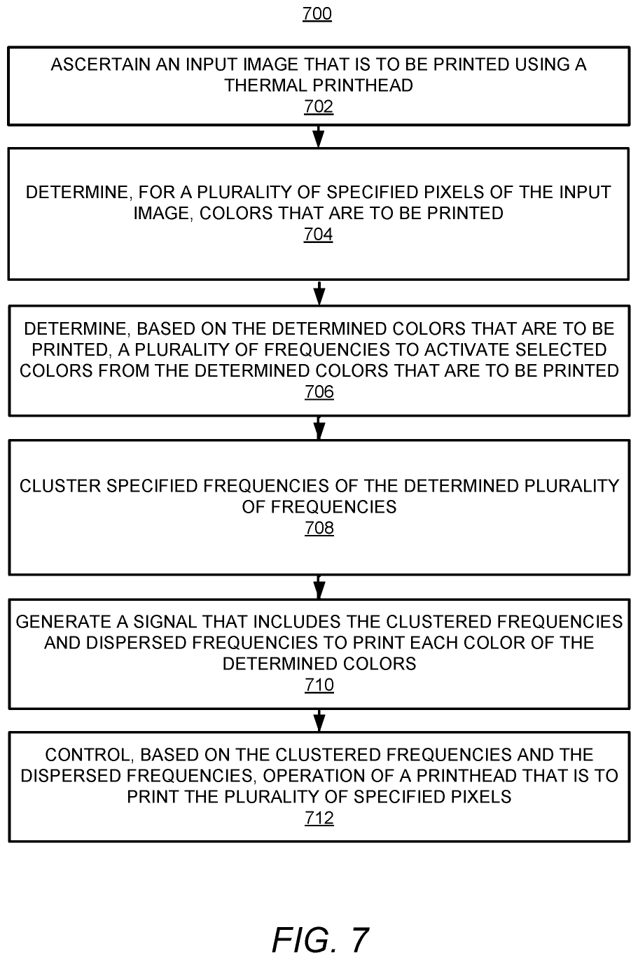

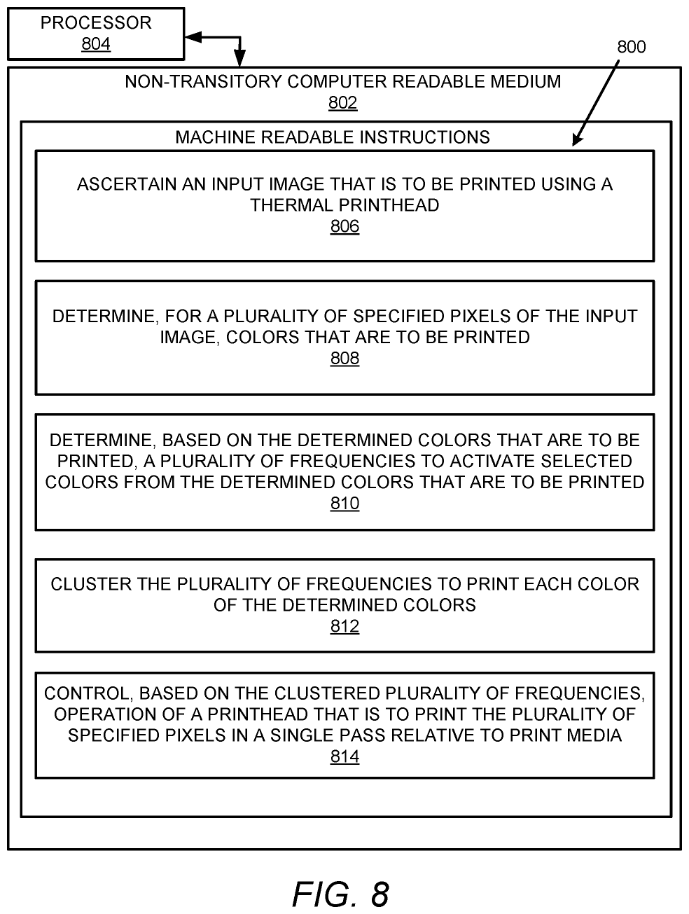

FIGS. 6-8 respectively illustrate an example block diagram 600, an example flowchart of a method 700, and a further example block diagram 800 for simultaneous color development for thermally activated print media. The block diagram 600, the method 700, and the block diagram 800 may be implemented on the apparatus 100 described above with reference to FIG. 1 by way of example and not limitation. The block diagram 600, the method 700, and the block diagram 800 may be practiced in other apparatus. In addition to showing the block diagram 600, FIG. 6 shows hardware of the apparatus 100 that may execute the instructions of the block diagram 600. The hardware may include a processor 602, and a memory 604 (i.e., a non-transitory computer readable medium) storing machine readable instructions that when executed by the processor 602 cause the processor to perform the instructions of the block diagram 600. The memory 604 may represent a non-transitory computer readable medium. FIG. 7 may represent a method for performing simultaneous color development for thermally activated print media. FIG. 8 may represent a non-transitory computer readable medium 802 having stored thereon machine readable instructions to perform simultaneous color development for thermally activated print media. The machine readable instructions, when executed, cause a processor 804 to perform the instructions of the block diagram 800 also shown in FIG. 8.

The processor 602 of FIG. 6 and/or the processor 804 of FIG. 8 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 802 of FIG. 8), such as hardware storage devices (e.g., RAM (random access memory), ROM (read only memory), EPROM (erasable, programmable ROM), EEPROM (electrically erasable, programmable ROM), hard drives, and flash memory). The memory 604 may include a RAM, where the machine readable instructions and data for a processor may reside during runtime.

Referring to FIGS. 1-6, and particularly to the block diagram 600 shown in FIG. 6, the memory 604 may include instructions 606 to ascertain an input image 104 that is to be printed using a thermal printhead 106.

The processor 602 may fetch, decode, and execute the instructions 608 to determine, for a plurality of specified pixels of the input image 104, colors that are to be printed.

The processor 602 may fetch, decode, and execute the instructions 610 to cluster the plurality of frequencies to print each color of the determined colors.

The processor 602 may fetch, decode, and execute the instructions 612 to control, based on the clustered plurality of frequencies, operation of the printhead 106 that is to print the plurality of specified pixels.

Referring to FIGS. 1-5 and 7, and particularly FIG. 7, for the method 700, at block 702, the method may include ascertaining an input image 104 that is to be printed using a thermal printhead 106.

At block 704, the method may include determining, for a plurality of specified pixels of the input image, colors that are to be printed.

At block 706, the method may include determining, based on the determined colors that are to be printed, a plurality of frequencies to activate selected colors from the determined colors that are to be printed.

At block 708, the method may include clustering specified frequencies of the determined plurality of frequencies.

At block 710, the method may include generating a signal that includes the clustered frequencies and dispersed frequencies to print each color of the determined colors.

At block 712, the method may include controlling, based on the clustered frequencies and the dispersed frequencies, operation of a printhead 106 that is to print the plurality of specified pixels.

Referring to FIGS. 1-5 and 8, and particularly FIG. 8, for the block diagram 800, the non-transitory computer readable medium 802 may include instructions 806 to ascertain an input image 104 that is to be printed using a thermal printhead 106.

The processor 804 may fetch, decode, and execute the instructions 808 to determine, for a plurality of specified pixels of the input image 104, colors that are to be printed.

The processor 804 may fetch, decode, and execute the instructions 810 to determine, based on the determined colors that are to be printed, a plurality of frequencies to activate selected colors from the determined colors that are to be printed.

The processor 804 may fetch, decode, and execute the instructions 812 to cluster the plurality of frequencies to print each color of the determined colors.

The processor 804 may fetch, decode, and execute the instructions 814 to control, based on the clustered plurality of frequencies, operation of a printhead 106 that is to print the plurality of specified pixels in a single pass relative to print media.

What has been described and illustrated herein is an example along with some of its variations. The terms, descriptions and figures used herein are set forth by way of illustration and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium storing machine readable instructions that when executed by the processor cause the processor to:
ascertain an input image that is to be printed using a thermal printhead;
determine, for a plurality of specified pixels of the input image, colors that are to be printed;
cluster a plurality of frequencies to print each color of the determined colors; and
control, based on the clustered plurality of frequencies, operation of a printhead that is to print the plurality of specified pixels.

2. The apparatus according to claim 1, wherein the instructions to cluster the plurality of frequencies to print each color of the determined colors, are further to cause the processor to:
determine, based on the determined colors that are to be printed, the plurality of frequencies to activate selected colors from the determined colors that are to be printed, wherein a number of the selected colors that represent primary colors is less than a number of the determined colors.

3. The apparatus according to claim 2, wherein the selected colors include cyan (C), magenta (M), and yellow (Y).

4. The apparatus according to claim 3, wherein the determined colors include colors that are intermediate to C, M, and Y.

5. The apparatus according to claim 1, wherein the instructions to control, based on the clustered plurality of frequencies, operation of the printhead that is to print the plurality of specified pixels, are further to cause the processor to:
repeat a signal including the clustered plurality of frequencies across pixel boundaries of the plurality of specified pixels.

6. The apparatus according to claim 1, wherein the instructions to cluster the plurality of frequencies to print each color of the determined colors, are further to cause the processor to:
cluster the plurality of frequencies into a plurality of clusters of equal width.

7. The apparatus according to claim 1, wherein the instructions to cluster the plurality of frequencies to print each color of the determined colors, are further to cause the processor to:
cluster the plurality of frequencies into a plurality of clusters of un-equal width.

8. The apparatus according to claim 1, wherein the instructions to control, based on the clustered plurality of frequencies, operation of the printhead that is to print the plurality of specified pixels, are further to cause the processor to:
control, based on the clustered plurality of frequencies, operation of the printhead that is to print the plurality of specified pixels in a single pass relative to print media.

9. A computer implemented method comprising:
ascertaining an input image that is to be printed using a thermal printhead;
determining, for a plurality of specified pixels of the input image, colors that are to be printed;
determining, based on the determined colors that are to be printed, a plurality of frequencies to activate selected colors from the determined colors that are to be printed;
clustering specified frequencies of the determined plurality of frequencies;
generating a signal that includes the clustered frequencies and dispersed frequencies to print each color of the determined colors; and
controlling, based on the clustered frequencies and the dispersed frequencies, operation of a printhead that is to print the plurality of specified pixels.

10. The computer implemented method according to claim 9, wherein a number of the selected colors is less than a number of the determined colors.

11. The computer implemented method according to claim 9, wherein the selected colors include cyan (C), magenta (M), and yellow (Y).

12. The computer implemented method according to claim 11, wherein the determined colors include colors that are intermediate to C, M, and Y.

13. A non-transitory computer readable medium having stored thereon machine readable instructions, the machine readable instructions, when executed, cause a processor to:
ascertain an input image that is to be printed using a thermal printhead;
determine, for a plurality of specified pixels of the input image, colors that are to be printed;
determine, based on the determined colors that are to be printed, a plurality of frequencies to activate selected colors from the determined colors that are to be printed;
cluster the plurality of frequencies to print each color of the determined colors; and
control, based on the clustered plurality of frequencies, operation of a printhead that is to print the plurality of specified pixels in a single pass relative to print media.

14. The non-transitory computer readable medium according to claim 13, wherein the machine readable instructions to cluster the plurality of frequencies to print each color of the determined colors, when executed, further cause the processor to:
cluster the plurality of frequencies into a plurality of clusters of equal width.

15. The non-transitory computer readable medium according to claim 13, wherein the machine readable instructions to cluster the plurality of frequencies to print each color of the determined colors, when executed, further cause the processor to:
cluster the plurality of frequencies into a plurality of clusters of equal and un-equal width.
